(19) United States
(12) Patent Application Publication
(10) Pub. No.: US 2006/0142800 A1
(43) Pub. Date: Jun. 29, 2006

(54) Infant teething and feeding apparatus

(75) Inventors: James Anthony Charameda, Holland, MI (US); Kim Hayes, Rockford, MI (US); Timothy Edwards, Holland, MI (US); Jeffery Martin, East Grand Rapids, MI (US); Rene Polin, Willoughby, OH (US)

Correspondence Address: GREENBERG TRAURIG, LLP, 77 WEST WACKER DRIVE, SUITE 2500, CHICAGO, IL, 60601-1732, US

(73) Assignee: Sassy, Inc., Bannockburn, IL (US)

(21) Appl. No.: 11/023,232

(22) Filed: Dec. 27, 2004

(51) Int. Cl. A61J 17/00

(52) U.S. Cl. 606/235

(57) ABSTRACT

An infant teething and feeding apparatus having a child-proof locking mechanism, reducing the likelihood of the assembled apparatus becoming inadvertently or prematurely disassembled by a young child and, in turn, preventing an associated food containing member from becoming separated from the overall device, absent intervention by an adult, and thus becoming a choking hazard to the child. A handle assembly of the apparatus includes a cooling insert for chilling, or maintaining the chilled condition, of food contained within the food containing member. A cap, or cover is provided to assist in maintaining the freshness of food contained within the apparatus, as well as to prevent the food contained within the apparatus from soiling clothing or other objects while the apparatus is being transported.

### BACKGROUND OF THE INVENTION

1. Field of the Invention

The present invention relates in general to teething and feeding apparatuses, and, more particularly, to combined teething and feeding apparatuses for use by infants and young children.

2. Background and the Prior Art

Teething and feeding devices, such as for children six months of age and older, are generally known. Some such apparatuses have been directed solely to the teething of young infants. Other apparatuses have been directed to both teething and feeding, with the intention of providing infants and young children with soft and semi-solid foods, within a resilient or soft container, with the intention of reducing the risk that the infant or young child will choke on the food contained therein.

Bridges, U.S. Pat. No. 1,095,264, discloses a teething device for the circulation of a cooling liquid, such as water, between an insulated receptacle and an attached nipple having no external aperture. Vertical and horizontal passageways within the nipple are said to facilitate the circulation of the cooling liquid between the nipple and the insulated receptacle.

Pecora, U.S. Pat. No. 2,665,693, discloses an infant teething and feeding device, including a nipple having a plurality of apertures through which various foods, such as scraped apples, crushed fruits, and breads, may pass through and be eaten. When assembled, a flange proximate the opening of the nipple is clamped between opposing disks of a carrier and a threadedly attached handle.

Mullin, U.S. Pat. No. 3,022,915, discloses an infant's pacifier, for attachment to a conventional nursing bottle. A dust guard or covering cap, can be fitted over the nipple of the pacifier.

Endrody, U.S. Pat. No. 3,742,950, discloses an infant teething and feeding device, including an embodiment having a meshed sack, provided with a resilient mouth to permit the filling of the sack with food pieces. The meshed sack is carried within a housing having a plurality of openings, through which food contained within the meshed sack may pass and be eaten. Tongue and socket fasteners are employed to close the container about the meshed sack.

Berry, Sr., U.S. Pat. No. 5,364,348, discloses a feeding device for young children or impaired adults. A meshed food dispensing member is filled with soft, solid, or semi-solid food, and then secured to an associated handle, by capturing a portion of the meshed sack, proximate the opening, between male threads on the exterior of the handle and associated female threads on the interior of a securing ring. A drawstring is disclosed at the opening of the food dispensing member, and may be tied to the handle to retain the food containing member in attachment to the handle, should the ring become loosened.

Berry, Sr., U.S. Pat. No. 6,524,272, discloses another feeding device for young children and impaired adults, wherein a rigid ring is provided at the opening of a meshed food container. In one embodiment, a single rigid ring is securely attached to the open end of the meshed sack, such as by stitching, gluing or sonic welding. In a second embodiment, a two-piece ring construction is employed, wherein an unhemmed opening of the meshed bag is secured between two cooperating, press-fitted ring portions. For both embodiments, the single and two-piece rigid rings are said to be of sufficient rigidity and diameter as to prevent the meshed sack from being swallowed, when it is separated from the remainder of the feeding device, such as during washing of the product components.

Accordingly, in contrast to several prior art references which fail to address the security of all of the device's components when in the hands of a child, it is an object of the present invention to provide an infant and teething apparatus having a child-proof locking mechanism which significantly reduces the ability of a child to disassemble the apparatus, reducing the likelihood that the assembled apparatus should become inadvertently or prematurely disassembled by a child, preventing the associated food container from becoming separated from the overall assembled apparatus and thus becoming a potential choking hazard, thus obviating the need for rigid ring structures.

It is another object of the present invention to provide an infant teething and feeding apparatus that is capable of chilling food contained within the apparatus, and of keeping chilled food contained within the apparatus in a chilled state.

It is a further object of the present invention to provide an infant feeding and teething apparatus that includes a cap, or cover, to assist in maintaining the freshness of foods contained within the apparatus, as well as to prevent food contained within the apparatus from soiling clothing or other objects while the apparatus is being transported.

These and other desirous characteristics of the present invention will become apparent in light of the present specification, claims and drawings.

### SUMMARY OF THE INVENTION

The present invention comprises a teething and feeding apparatus for an infant or young child, including a housing, and a food containing member releaseably securable in position proximate the housing. The food containing member has an outer surface, an interior region, a first end and a closed second end, and an opening through the outer surface proximate the first end, permitting food to be inserted through the opening and into the interior region. The outer surface has a plurality of apertures therethrough. The apertures are sized to permit small portions of the food to be drawn out of the food containing member when an infant or young child sucks on the food containing member.

A child-proof locking mechanism permits the food containing member to be releaseably secured in position proximate the housing, and serves to inhibit premature release of the food containing member from proximity to the housing absent intervention by an adult. This inhibits the food containing member and the food carried therein from becoming a choking hazard to the infant or young child when prematurely separated from proximity to the housing by the infant or young child.

The housing includes a first surface, and the apparatus further includes a retaining member securable to the housing and having a flange. The flange has an interior surface, an exterior surface, and an aperture through the flange. The aperture of the flange is sized to permit the closed second end of the food containing member to be inserted through the aperture of the flange. The first end of the food containing member is clamped between the interior surface of the flange and the first surface of the housing when the retaining member is secured to the housing. The child-proof locking mechanism thus inhibits the unclamping of the first end of the food containing member until the child-proof locking mechanism is released.

The housing further includes a first attachment region, and the retaining member further includes a second attachment region. The retaining member is secured to the housing through operative engagement of the first and second attachment regions. The child-proof locking mechanism thus inhibits disengagement of the first and second attachment regions until the child-proof locking mechanism is released.

The first attachment region includes a first threaded portion, and the second attachment region includes a second threaded portion. The retaining member is secured to the housing through threaded engagement of the first threaded portion and the second threaded portion.

The retaining member includes at least one ratcheting protrusion, and the child-proof locking mechanism includes at least one ratcheting protrusion. The engagement of the at least one ratcheting protrusion of the child-proof locking mechanism with the at least one ratcheting protrusion of the retaining member inhibits separation of the retaining member and, in turn, the food containing member from the housing until the child-proof locking mechanism is released.

In a preferred embodiment, the retaining member includes a plurality of ratcheting protrusions. Moreover, in this preferred embodiment, the child-proof locking mechanism includes a plurality of ratcheting protrusions. At least one of the ratcheting protrusions of at least one of the retaining member and the child-proof locking mechanism is spring loaded.

At least one of the housing and the retaining member further includes a barrier serving to inhibit the first end of the food containing member from being pulled through the aperture of the flange when the first end of the food containing member is clamped between the interior surface of the flange and the first surface of the housing. In a preferred embodiment, the barrier is operably attached to the first surface of the housing, and comprises an annular compression ridge.

The food containing member further includes a flexible filament disposed about at least a portion of the opening of the food containing member. The flexible filament is also disposed about at least a portion of the barrier when the first end of food containing member is clamped between the interior surface of the flange and the first surface of the housing. The barrier thus serves to inhibit the flexible filament, and, in turn, the first end of the food containing member from being pulled through the aperture of the flange. Moreover, the flexible filament is carried within a hem proximate the opening of the mesh bag.

A cooling member is provided proximate at least a portion of the food containing member when the food containing member is secured proximate the housing. This cooling member serves to perform at least one of chilling the food and preserving a chilled condition of the food contained within the food containing member. A least a portion of the cooling member is carried within the housing. Moreover, at least a portion of the cooling member protrudes from a surface of the housing. In a preferred embodiment, a dome shaped portion of the cooling member protrudes from the surface of the housing.

In a preferred embodiment, at least a portion of the cooling member is of hollow construction, and is filled with a liquid, such as water.

A cover is provided, covering at least a portion of the food containing member. The cover is releasable attachable to the housing by the snap-fit engagement of a portion of the cover with a portion of the housing.

A handle is provided, and is operably attached to the housing. The food containing member is preferably constructed from a mesh material, such as a nylon mesh.

A cover, covering at least a portion of the food containing member, is also provided. The cover is releasable attachable to the housing, and is attachable to the cover by snap-fit engagement of a portion of the cover with a portion of the housing.

### BRIEF DESCRIPTION OF THE DRAWINGS

FIG. 1 of the drawings is an exploded perspective view of the overall infant teething and feeding apparatus, including a simplified view of the food containing member;

FIG. 2 of the drawings is a bottom perspective view of the handle housing;

FIG. 3 of the drawings is a bottom view of the handle housing;

FIG. 4 of the drawings is a bottom view of the latching member;

FIG. 5 of the drawings is a bottom perspective view of the cooling insert;

FIG. 6 of the drawings is a bottom perspective view of the cooling insert retaining member;

FIG. 7A of the drawings is a front elevational view of the flexible filament, in its uncoiled configuration;

FIG. 7B of the drawings is a front elevational view of the flexible filament, in its coiled configuration;

FIG. 8 of the drawings is a top perspective, detailed view of the food containing member;

FIG. 9 of the drawings is a bottom perspective view of the twist-on retaining member;

FIG. 10 of the drawings is a front elevational view of the fully assembled feeding and teething apparatus; and

FIG. 11 of the drawings is a sectional view of the fully assembled infant feeding and teething apparatus, including a simplified view of the food containing member and an alternative construction of the cooling insert, taken generally along lines 11-11 of FIG. 10.

### DETAILED DESCRIPTION OF THE DRAWINGS

While this invention is susceptible of embodiment in many different forms, there are shown in the drawings and will herein be described in detail, several specific embodiments, with the understanding that the present disclosure is to be considered as an exemplification of the principles of the present invention and is not intended to limit the invention to the embodiments illustrated.

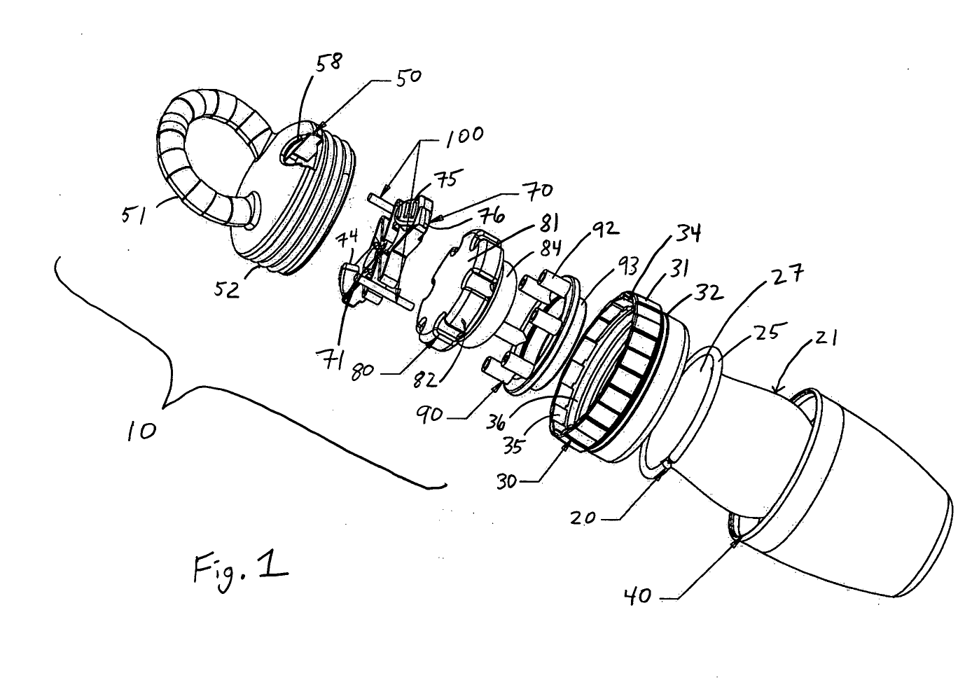

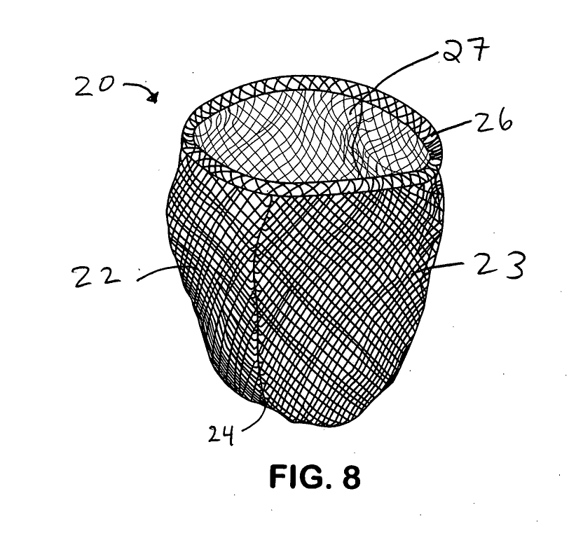

The present infant teething and feeding apparatus is shown in FIG. 1 as comprising handle assembly 10, food containing member 20 (shown in a simplified view in FIG. 1 and in detailed view in FIG. 8), twist-on retaining member 30, and cover, or cap 40. Handle assembly 10, in turn, comprises handle housing 50, latching member 70, cooling insert 80, cooling insert retaining member 90, and knurl pins 100.

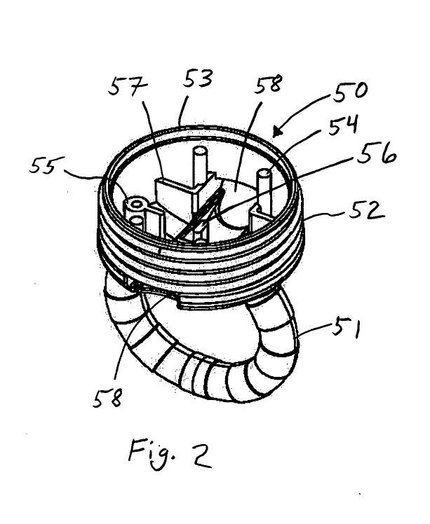

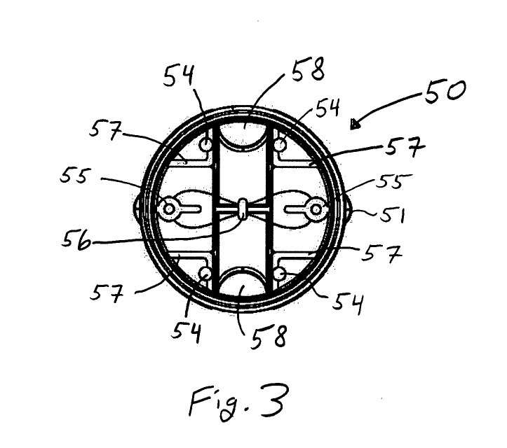

As shown in FIGS. 2 and 3, handle housing 50 includes handle 51, proximate the top surface of the handle housing. Although handle 51 is preferably textured, having a plurality of slightly raised regions, to facilitate the gripping of handle 51 by a young child, a handle of smooth construction may alternatively be used. Handle housing 50 further includes male-threaded attachment region 52, disposed about an outer, cylindrical surface, with a large bottom aperture 53. Within an interior region of the handle housing, four integrally formed posts 54, and two integrally formed sockets 55, are provided to facilitate attachment of the knurl pins and cooling insert retainer within a fully assembled handle assembly. Webs 57 serve to further support posts 54, and, in addition, provide a substantially planar base, together with the assembled latching member, to support the upper surface of the cooling insert when handle assembly 10 is fully assembled. Additional webs within the interior of handle housing 50 serve to support oval stud 56, which, in turn, serves to position and anchor the latching member within the fully assembled handle assembly. Two opposing latch apertures 58, each disposed through opposing portions of the attachment region and upper surface of handle housing 50, accept the button and ratcheting protrusions of the latching member, permitting them to be depressed inwardly from the exterior of the handle housing. Handle housing 50 is preferably formed from a single piece of rigid plastic material, and may be formed, for example, by injection molding.

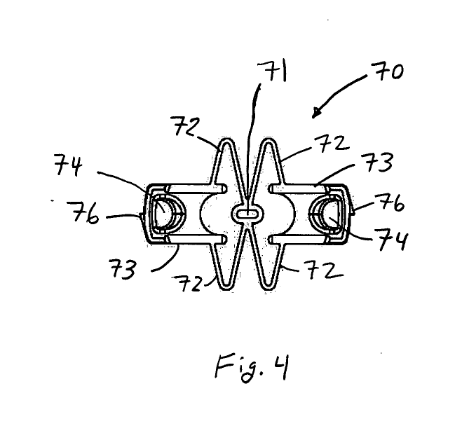

Latching member 70 is shown in FIGS. 1 and 4 as comprising center oval slot 71, spring members 72, and two opposing arms 73. Center oval slot 71 receives oval stud 56 of the handle housing, such that latching member 70 is retained within a centered position, relative to handle housing 50, within the fully assembled handle assembly. When in their uncompressed state, as shown in FIG. 4, spring members 72 maintain opposing arms 73 at a predetermined distance from each other, and from center oval slot 71. Each opposing arm 73 includes an associated curved button 74 which, as best seen in FIG. 1, each include three raised ribs 75 to facilitate the gripping of buttons 74.

Latching member 70 is preferably made of a relatively rigid plastic material, although not so rigid as to inhibit the spring-like action of spring members 72. In particular, when sufficient opposing pressure is applied to buttons 74, all four spring members 72 compress inwardly, allowing the two opposing arms 73, and, in turn, the associated ratcheting protrusions 76, disposed on the outer surfaces of each opposing arm, to move slightly inwardly, towards center oval slot 71. When this opposing inward pressure is removed, spring members 72, and latching member 70 overall, return to their uncompressed state, as shown in FIG. 4.

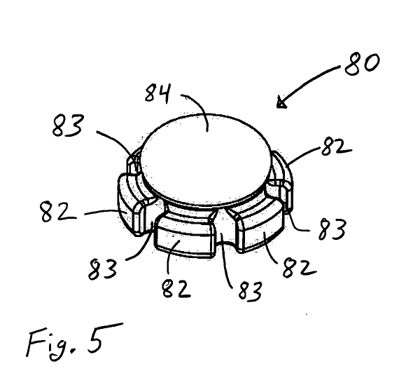

Cooling insert 80 is shown in FIGS. 1 and 5 as comprising a substantially flat upper surface 81, six lugs 82, six recessed regions 83, each disposed between two adjacent lugs, and domed lower surface 84. Within the fully assembled handle assembly, substantially flat upper surface 81 of cooling insert 80 rests, and is held firmly by cooling insert retaining member 90, against L-shaped webs 57 of the handle housing (as shown in FIG. 3), as well as against the upper surface of latching member 70 (FIG. 4), although not so firmly as to preclude the movement of opposing arms 73 and spring members 72 of latching member 70. Recessed regions 83 of cooling insert 80 permit passage of knurl pins 100, as well as the cooperating posts and sockets of handle housing 50 and cooling insert retaining member 90, which, in turn, together with lugs 82, serve to inhibit rotational movement of cooling insert 80 within fully assembled handle assembly 10.

In a preferred embodiment, cooling insert 80 is of hollow construction, and contains a suitable liquid capable of being refrigerated, such as water. Moreover, while the upper surface and lugs of cooling insert 80 are preferably of a relatively rigid plastic material, domed lower surface 84 is preferably of a somewhat more flexible, resilient plastic. Alternatively, similar materials may be employed for all of cooling insert 80, with the material of the upper surface and lugs being thicker in cross section than the material of the domed lower surface towards providing a rigid upper surface and lugs, and a relatively resilient domed lower surface.

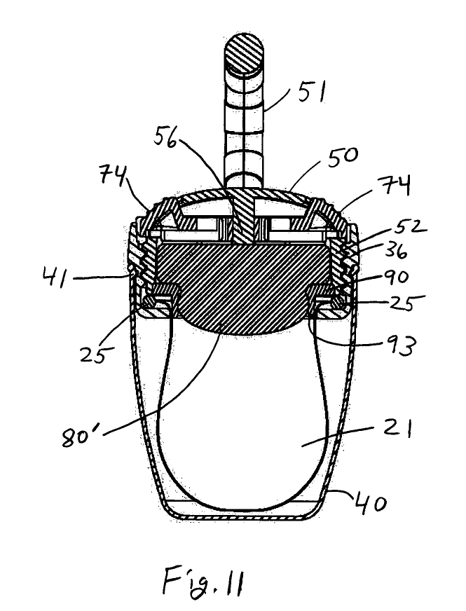

Although, in a preferred embodiment, a liquid such as water is contained within cooling insert 80, other refrigerable materials, such as suitable gels, may alternatively be used. Moreover, although, in a preferred embodiment, cooling insert 80 is of a hollow construction and contains a fluid capable of being refrigerated, and, subsequently, chilling, or maintaining the chilled condition, of food contained adjacently within the food containing member, cooling insert 80 may alternatively be constructed of a solid material, which, in and of itself, provides the desired properties of being capable of being refrigerated, and then chilling or maintaining the chilled condition of adjacent food. A cooling insert 80′ of solid construction is shown in cross-section in FIG. 11.

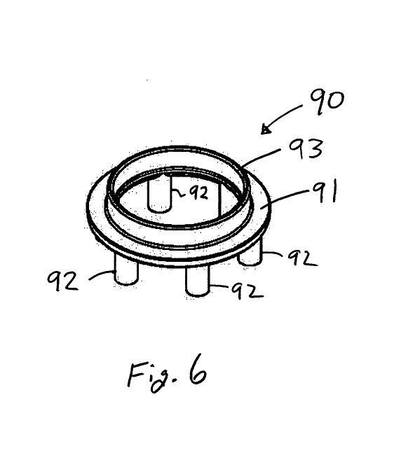

As shown in FIGS. 1 and 6, cooling insert retaining member 90 includes an bottom surface 91, having an annular compression ridge 93 surrounding and aperture through the surface of the cooling insert retaining member. Six cylindrical sockets 92 extend from the upper surface of cooling insert retainer 90. When handle assembly 10 is fully assembled, lower surface 91 of cooling insert retainer 90, together with the domed lower surface 94 of the cooling insert, forms an overall lower surface of the handle assembly.

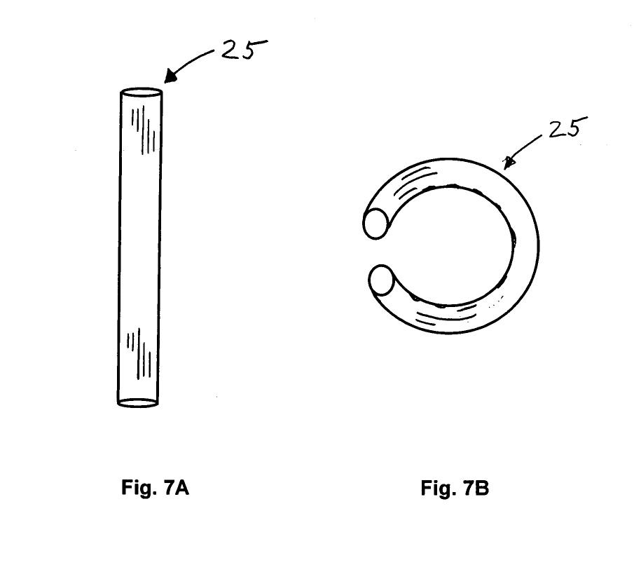

Food containing member 20 is shown in FIG. 1 (in a simplified view) and in FIG. 8 (in detailed view) as comprising mesh bag 21. As shown in FIG. 8, mesh bag 21, is, in a preferred embodiment, constructed from two semi-circular halves, 22, 23, joined at longitudinal seam 24. Food containing member 20 further comprises flexible rod or filament 25, having an uncoiled configuration, as shown in FIG. 7A, and a coiled, “c-shaped” configuration, as shown in FIG. 7B. Flexible rod or filament 25, which is preferably constructed of a flexible plastic material, is operably attached to food containing member 20 in its coiled configuration proximate upper aperture 27.

In a preferred embodiment, longitudinal seam 24 is formed by stitching semi-circular halves 22, 23 together. Moreover, in a preferred embodiment, flexible filament 25 is secured about aperture 27 by stitching filament 25 within an annular hem disposed at the upper surface of food containing member 20, so as to create resilient aperture 27. Mesh bag 21 may be manufactured in quantity, for example, by stitching a significant length of flexible filament material along one edge of a corresponding significant length of mesh material into a longitudinal hem, transversely cutting the mesh material and the hemmed flexible filament into discrete segments, and then stitching the two opposing vertical ends of each segment together, while simultaneously coiling the flexible filament.

Moreover, in a preferred embodiment, mesh bag 21 is preferably constructed of a nylon, or nylon-like material, having approximately 15 openings per linear inch (i.e., approximately 225 openings per square inch) through which food contained within the interior region of food containing member 20 may pass. Longitudinal seam 24, and hem 26, are preferably formed using conventional stitching methods. Alternatively, other forms of attaching semi-circular halves 22 and 23, may be employed, such as the use of a strong, non-toxic adhesive. Similarly, flexible filaments 25 may be attached to mesh bag 21 proximate aperture 27 using means other than a stitched hem, such as, for example, again using a strong, non-toxic adhesive.

Moreover, although, in a preferred embodiment, mesh bag 21 is constructed of two semi-circular halves, other forms of construction are also contemplated. For example, mesh bag 21 may be formed from any number of individual portions of mesh material, yielding a plurality of associated seams. Alternatively, mesh bag 21 may be constructed from a single, seamless piece of mesh material. Moreover, although, in a preferred embodiment, nylon or a nylon-like material is employed for mesh bag 21, alternative compositions may also be used for mesh bag 21, provided the material chosen has the desired characteristics of being strong enough to be repeatedly chewed by a teething child without tearing or disintegration, and having sufficient porosity to allow food contained within food containing member 20 to pass therethrough, and, preferably, being machine washable.

Referring to FIG. 1, handle housing 50, latching member 70, cooling insert 80, cooling insert retainer 90, and knurl pins 70 are collectively assembled together to form handle assembly 10 as follows. First, latching member 70 is operably attached to handle housing 50, by compressing spring members 72 while inserting curved buttons 74 of opposing arms 73 through associated latch apertures 58 of handle housing 50. Center oval slot 71 of latching member 70 is positioned about oval stud 56 of handle housing 50, and spring members 72 of latching member 70 are allowed to re-expand, permitting ratcheting protrusions 76, disposed on opposing ends of arms 73, to protrude through latch apertures 58.

Next, the upper portion of cooling insert 80 is inserted into the interior of handle housing 50, such that the substantially planar upper surface 81 of cooling insert 80 is adjacent, and supported by, L-shaped webs 57 and oval stud 56 of handle housing 50, and is also adjacent and supported by the lower surface of latching member 70. Moreover, lugs 82 of cooling insert 80 are positioned surrounding posts 54 of handle housing 50, such that each post 54 is adjacent an associated recessed region 83 of cooling insert 80.

The top ends of knurl pins 100 are next firmly inserted into associated sockets 55 within handle housing 50. Next, cooling insert retaining member 90 is operably attached to handle housing 50, by inserting sockets 92 extending from the upper surface of cooling insert retainer 90, such that each is firmly coupled to and positioned about an associated post 54 or bottom end knurl pin 100 within handle housing 50. Cooling insert retaining member 90 is press-fit tightly in place with each socket 92 positioned within an associated recessed region 83 of cooling insert 80. Once cooling insert retainer 90 is fully inserted, lower surface 91 of cooling insert retaining member 90 forms an overall annular lower surface of handle assembly 10. Annular compression ridge 93 extends outwardly from lower surface 91, and, in fully assembled handle assembly 10, is disposed about domed end 84 of cooling insert 80, which protrudes from within handle housing 50.

Once so assembled, all of the components of handle assembly 10 are held firmly in place, as handle assembly 10 is not intended to be disassembled by the consumer, and tools, such as a thin-bladed knife, are required to subsequently separate cooling insert retaining member 90 from handle housing 50 once it has been press-fit in place.

In operation, handle assembly 10, or the entirety of the present infant teething and feeding apparatus, is optionally refrigerated in order to cool cooling insert 80. Next, age-appropriate foods, such as banana portions or portions of crushed or sliced fruits or vegetables, are inserted through aperture 27 of food containing member 20. Next, the lower, closed end of food containing member 20, opposite the upper aperture end, is inserted first through the larger, top aperture 34 and then through the smaller, bottom aperture of bottom surface 33 of twist-on retaining member 30, until hem 26, and, in turn, flexible filament 25, are adjacent the inner surface of the flange at the lower portion of twist-on retaining member 30. Alternatively, food containing member 20 may be coupled to twist-on retaining member 30 in this fashion prior to the placement of the food within food containing member 20.

Twist-on retaining member 30 is then threadedly advanced about male-threaded attachment region 52 of handle housing 50, with female-threaded attachment region 36 cooperating with male-threaded attachment region 52. After several revolutions of twist-on retaining member 30, relative to handle housing 50, ratcheting protrusions 76 disposed on the outer surfaces of opposing arms 73 begin to engage associated ratcheting protrusions 35 disposed about the inner circumference of twist-on retaining member 30. Once so engaged, the cooperating ratcheting protrusions of twist-on retaining member 30 and latching member 70 serve to provide a childproof locking mechanism, whereby, absent simultaneous inward depression of the child-proof lock releasing buttons 74, twist-on retaining member 30 may be further tightened about male-threaded attachment region 52 of handle housing 50, but may not be unscrewed or otherwise loosened. Twist-on retaining member 30 is then further and fully tightened in attachment to handle housing 50 through several additional revolutions of twist-on retaining member 30 about attachment region 52 of handle housing 50.

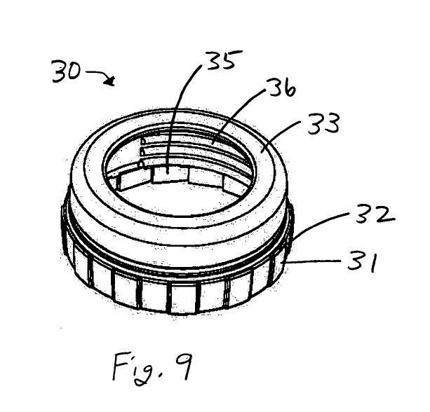

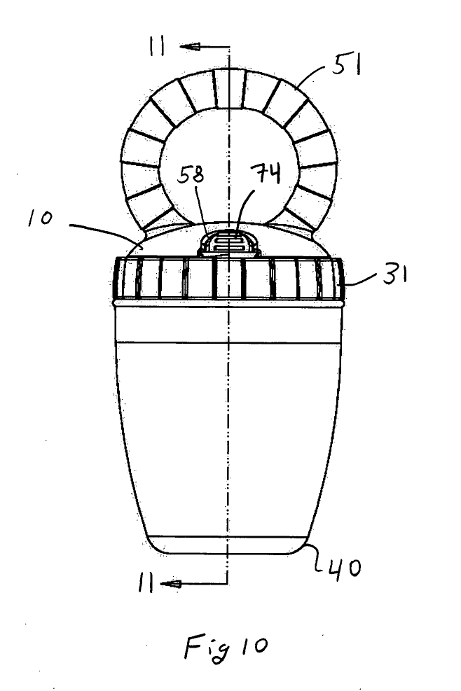

As shown in FIGS. 9 and 11, once twist-on retaining member 30 is fully threadedly advanced in attachment to handle assembly 10, hem 26, and, in turn, flexible filament 25 of food containing member 20 is securely clamped between a lower surface of handle assembly 10 and an inner surface of twist-on retaining member 30 at the interior surface of the lower flange of twist-on retaining member 30. Moreover, as best seen in FIG. 11, annular compression ridge 93 of cooling insert retainer 90 serves as a physical barrier to inhibit hem 26 and flexible filament 25 from being pulled through the bottom aperture of the twist-on retaining member, and, in turn, to inhibit food containing member 20 from being prematurely separated by a child from handle assembly 10, absent the intervention of an adult. At this time, the fully assembled infant teething and feeding apparatus may be safely handed to a young child, who may teeth upon the mesh bag, and who may draw food contained therein through the apertures of the mesh material by sucking upon food containing member 20. Moreover, as best seen in FIG. 11, cover, or cap 40 may be releasably snap-fit in place surrounding food containing member 20, by advancing the upper aperture of cap 40 about the outer surface of twist-on retaining member 30, until interior bead 41, disposed about the inner circumference of cap 40 proximate its upper aperture, engages cooperating annular groove 32 about the outer circumference of twist-on retaining member 30. As a relatively airtight seal is thus provided about food-containing member 20, cover or cap 40 may be used to preserve the freshness of food contained within food containing member 20, and to prevent the leakage of same through the apertures of the mesh material from soiling clothing or other objects, such as when the infant teething and feeding apparatus is being transported.

Once the child has finished using the infant teething and feeding apparatus, an adult may disassemble the twist-on retaining member and, in turn, the food containing member from the handle assembly, by simultaneously pressing opposing buttons 74 of latching member 70 inwardly. This, in turn, causing ratcheting protrusions 76 at opposing ends of latching member 70 to simultaneously disengage from the associated ratcheting protrusions 35 disposed about the interior circumference of retaining member 30. While buttons 75 are continuously and firmly pressed inwardly, temporarily compressing associated spring members 72 of latching member 70, twist-on retaining member 30, and, in turn, food containing member 20, may be unscrewed from handle assembly 10. Food containing member 20 may then be separated from twist-on retaining member 30, permitting food containing member 20 to then be cleaned, either by hand washing, or by placement within an automatic dishwasher.

Twist-on retaining member 30 is shown in FIGS. 1 and 9 as comprising an outer surface, including annular textured gripping region 31, and an annular groove 32, disposed about the outer surface of the twist-on retaining member, proximate the textured gripping region. Annular groove 32 cooperates with a corresponding annular bead disposed about the inner circumference of storage cap 40, enabling storage cap 40 to be releasably snap-fit together with twist-on retaining member 30, providing a relatively air-tight seal about food containing member 20.

Bottom surface 33 of twist-on retaining member 10 includes an aperture therethrough of sufficient size to permit the top portion of food containing member 20 to easily pass therethrough. Twist-on retaining member 30 further includes a larger top aperture 34, opposite the smaller bottom aperture and permitting the entirety of food containing member 20, including flexible filament 25 and hem 26, to pass easily therethrough. The interior of twist-on retaining member 30 includes an annular series of ratcheting protrusions 35, disposed about the inner circumference of the twist-on retaining member, proximate top aperture 34. Twist-on retaining member 30 further includes annular female threaded attachment region 36, disposed about the inner circumference of the twist-on retaining member and adjacent to, and partially overlapping with, ratcheting protrusions 34.

The foregoing description and drawings merely explain and illustrate the invention, and the invention is not limited thereto, except insofar as the appended claims are so limited as those skilled in the art having the present disclosure before them will be able to make modifications and variations therein, without departing from the scope of the invention.

What is claimed is:

1. A teething and feeding apparatus for an infant or young child, comprising:
a housing;
a food containing member releaseably securable in position proximate the housing, the food containing member having an outer surface, an interior region, a first end and a closed second end, an opening through the outer surface proximate the first end permitting food to be inserted through the opening and into the interior region, the outer surface having a plurality of apertures therethrough, the apertures being sized to permit small portions of the food to be drawn out of the food containing member when an infant or young child sucks on the food containing member; and
a child-proof locking mechanism permitting the food containing member to be releaseably secured in position proximate the housing, the child-proof locking mechanism serving to inhibit premature release of the food containing member from proximity to the housing absent intervention by an adult, so as to inhibit the food containing member from becoming a choking hazard to the infant or young child when separated from proximity to the housing by the infant or young child.

2. The invention according to claim 1, wherein:
the housing includes a first surface;
the apparatus further includes a retaining member securable to the housing and having a flange, the flange having an interior surface, an exterior surface, and an aperture through the flange, the aperture of the flange being sized to permit the closed second end of the food containing member to be inserted through the aperture of the flange, the first end of the food containing member being clamped between the interior surface of the flange and the first surface of the housing when the retaining member is secured to the housing;
the child-proof locking mechanism inhibiting the unclamping of the first end of the food containing member until the child-proof locking mechanism is released.

3. The invention according to claim 2 wherein:
the housing further includes a first attachment region;
the retaining member further includes a second attachment region;
the retaining member is secured to the housing through operative engagement of the first and second attachment regions; and
the child-proof locking mechanism inhibits disengagement of the first and second attachment regions until the child-proof locking mechanism is released.

4. The invention according to claim 3, wherein:
the first attachment region includes a first threaded portion;
the second attachment region includes a second threaded portion; and
the retaining member is secured to the housing through threaded engagement of the first threaded portion and the second threaded portion.

5. The invention according to claim 2 wherein:
the retaining member includes at least one ratcheting protrusion;
the child-proof locking mechanism includes at least one ratcheting protrusion; and
engagement of the at least one ratcheting protrusion of the child-proof locking mechanism with the at least one ratcheting protrusion of the retaining member inhibits separation of the retaining member and, in turn, the food containing member from the housing until the child-proof locking mechanism is released.

6. The invention according to claim 5 wherein the retaining member includes a plurality of ratcheting protrusions.

7. The invention according to claim 5 wherein the child-proof locking mechanism includes a plurality of ratcheting protrusions.

8. The invention according to claim 5 wherein at least one of the ratcheting protrusions of at least one of the retaining member and the child-proof locking mechanism is spring loaded.

9. The invention according to claim 2 wherein at least one of the housing and the retaining member further includes a barrier serving to inhibit the first end of the food containing member from being pulled through the aperture of the flange when the first end of the food containing member is clamped between the interior surface of the flange and the first surface of the housing.

10. The invention according to claim 9 wherein the barrier is operably attached to the first surface of the housing.

11. The invention according to claim 9 wherein the barrier comprises an annular compression ridge.

12. The invention according to claim 9, wherein the food containing member further includes a flexible filament disposed about at least a portion of the opening of the food containing member, the flexible filament being disposed about at least a portion of the barrier when the first end of food containing member is clamped between the interior surface of the flange and the first surface of the housing, the barrier serving to inhibit the flexible filament, and, in turn, the first end of the food containing member from being pulled through the aperture of the flange.

13. The invention according to claim 12, wherein the flexible filament is carried within a hem proximate the opening of the mesh bag.

14. The invention according to claim 1, further comprising a cooling member proximate at least a portion of the food containing member when the food containing member is secured proximate the housing, the cooling member serving to perform at least one of chilling the food and preserving a chilled condition of the food contained within the food containing member.

15. The invention according to claim 14 wherein at least a portion of the cooling member is carried within the housing.

16. The invention according to claim 14 wherein at least a portion of the cooling member protrudes from a surface of the housing.

17. The invention according to claim 14 wherein a dome shaped portion of the cooling member protrudes from the surface of the housing.

18. The invention according to claim 14 wherein at least a portion of the cooling member is of hollow construction.

19. The invention according to claim 18 wherein at least a portion of the cooling member is filled with a liquid.

20. The invention according to claim 19 wherein the liquid is water.

21. The invention according to claim 1, further comprising a cover covering at least a portion of the food containing member.

22. The invention according to claim 21 wherein the cover is releasable attachable to the housing.

23. The invention according to claim 22 wherein the cover is attachable to the housing by the snap-fit engagement of a portion of the cover with a portion of the housing.

24. The invention according to claim 1, further comprising a handle operably attached to the housing.

25. The invention according to claim 1, wherein the food containing member is constructed from a mesh material.

26. The invention according to claim 25, wherein the mesh material comprises nylon mesh.

27. A teething and feeding apparatus for an infant or young child, comprising:
a housing;
a food containing member releaseably securable proximate the housing, the food containing member having an outer surface, an interior region, a first end and a closed second end, an opening through the outer surface proximate the first end permitting food to be inserted through the opening and into the interior region, the outer surface having a plurality of apertures therethrough, the apertures being sized to permit small portions of the food to be drawn out of the food containing member when an infant or young child sucks on the food containing member; and
a cooling member proximate at least a portion of the food containing member when the food containing member is secured proximate the housing, the cooling member serving to perform at least one of chilling the food and preserving a chilled condition of the food contained within the food containing member.

28. The invention according to claim 27 wherein at least a portion of the cooling member is carried within the housing.

29. The invention according to claim 27 wherein at least a portion of the cooling member protrudes from a surface of the housing.

30. The invention according to claim 27 wherein a dome shaped portion of the cooling member protrudes from the surface of the housing.

31. The invention according to claim 27 wherein at least a portion of the cooling member is of hollow construction.

32. The invention according to claim 31 wherein at least a portion of the cooling member is filled with a liquid.

33. The invention according to claim 32 wherein the liquid is water.

34. A teething and feeding apparatus for an infant or young child, comprising:
a housing;
a food containing member releaseably securable in position proximate the housing, the food containing member having an outer surface, an interior region, a first end and a closed second end, an opening through the outer surface proximate the first end permitting food to be inserted through the opening and into the interior region, the outer surface having a plurality of apertures therethrough, the apertures being sized to permit small portions of the food to be drawn out of the food containing member when an infant or young child sucks on the food containing member; and
a cover covering at least a portion of the food containing member.

35. The invention according to claim 34 wherein the cover is releasable attachable to the housing.

36. The invention according to claim 35 wherein the removable cover is attachable to the cover by snap-fit engagement of a portion of the cover with a portion of the housing.
